(19) United States
(12) Patent Application Publication
(10) Pub. No.: US 2022/0022359 A1
(43) Pub. Date: Jan. 27, 2022

(54) Method for Weeding and a Weeding Rod

(71) Applicant: FarmDroid ApS, Vejen (DK)

(72) Inventors: Jens VEST WARMING, Rødding (DK); Kristian VEST WARMING, Vejen (DK); Peter FØRBY-MADSEN, Varde (DK)

(21) Appl. No.: 17/490,124

(22) Filed: Sep. 30, 2021

Related U.S. Application Data
(63) Continuation of application No. PCT/DK2020/050078, filed on Mar. 26, 2020.

(30) Foreign Application Priority Data
Apr. 4, 2019 (DK) PA 2019 00414

(51) Int. Cl. A01B 39/19; A01B 63/00; A01B 79/00

(52) U.S. Cl. CPC A01B 39/19; A01B 79/005; A01B 63/004

(57) ABSTRACT

A method for weeding between rows of crops and between individual plants in each row whereby a weeding rod is suspended at a proximal portion thereof and left un-suspended at a distal portion thereof whereby the suspension keeps the distal portion and proximal portion in the same horizontal plane. The method further comprises the step of ensuring that the weeding rod has a rounded cross section in a transverse plane with respect to a length axis thereof between the proximal portion and the distal portion and the further step of advancing the weeding rod below ground level in a direction along a ground plane.

### CROSS REFERENCE TO RELATED APPLICATIONS

This application is a continuation under 35 U.S.C. 111 of International Patent Application No. PCT/DK2020/050078, filed Mar. 26, 2020, which claims the benefit of and priority to Danish Application No. PA 2019 00414, filed Apr. 4, 2019, each of which is hereby incorporated by reference in its entirety.

### BACKGROUND

It is known that weeding may be performed by weeding irons which are advanced below the surface to cut weed roots. Such known weeding irons usually comprise a sharpened edge portion to ensure the smallest possible resistance when the iron penetrates the soil and cuts weed roots. However, it has been determined, that for weeding processes which are repeated often and as a result are directed at newly sprouted weeds, it is better to not cut the roots, but to pull the roots out of the ground as far as possible.

DE 32 46 527 discloses a weeding rod, which comprises an iron rod fastened to a shaft, which has an angled portion at its distal end adapted to be drawn or pushed below ground transversely to the length direction of the angled portion. No method for weeding whereby the speed of the weeding iron is kept within limits is disclosed.

Weeding implements comprising horizontally driven rods to be used alone or with well known cultivators such as harrows, which are to be drawn by tractors are widely known, and an illustrative example is provided in CA 1184 804. There are no methods associated with such implements which suggest that they be used with lower or upper speed limits for purposes of restricted energy consumption or wear. On the contrary, the known implements usually are designed for use with tractors driven at their highest possible speed, which commonly is well above 8 km/h.

Thus, there is a need for a method and a weeding iron, which will pull weeds out of the ground and continue to do so even when it has been worn down. A weeding method that consumes less energy than prior art weeding methods would also be desirable.

### SUMMARY

The present invention relates to a method for weeding in fields wherein the crop has been sown in rows. The present invention also relates to a weeding rod.

In an aspect, the invention comprises a method for weeding between rows of crops whereby a weeding rod is suspended from a vehicle part at a proximal portion of the weeding rod and left un-suspended at a distal portion thereof whereby the suspension keeps the distal portion and proximal portion in the same horizontal plane whereby a step ensuring that the weeding rod has a rounded cross section in a transverse plane with respect to a length axis thereof between the proximal portion and the distal portion is performed and the further step of advancing the weeding rod below ground level in a direction along a ground plane is performed. The first step is performed in that it is initially ensured that the rod has a rounded shape, and as wear will progress on surfaces facing the direction of movement such surfaces will wear down gradually and this will ensure that the shape remains rounded in any transverse cross section of the weeding rod. The second step of advancing the rod below surface but parallel hereto will ensure the mentioned wear, and at the same time the specified motion, will root up most newly established weeds, which is the desired effect. Weeds which are not rooted up, such as perennials like thistles, may have stem parts broken below the surface. The established suspension at one end of the weeding rod ensures that at the not-suspended end weed roots and other debris may slide off the rod during motion in the ground.

According to the invention the speed of the weeding rod in the motion direction with respect to the ground is between 0.3 and 5 km/h or between 0.4 and 1.0 km/h or between 0.5 and 0.8 km/h.

This is a very moderate speed compared to speeds used for conventional weeding, and the low speed also ensures that the weeding rod may be made with a moderate cross section, as it is not exposed to high momentums due to reaction forces from its forced movement in the ground. Also, the lower the thickness of the weeding rod, the lesser the forces, which are needed to propel it below the surface may be, and the lower the energy consumption of the weeding process will be. This is of importance as the weeding process is adapted to be powered by sunlight through the solar cells mounted on a farm robot which carries arrays of weeding rods.

Above the chassis of the vehicle there is mounted a solar panel, which may provide electrical power for the driving motion. Also, the vehicle may comprise a number of batteries or other power releasing devices in order to ensure propulsion power to the driving wheels.

Electrical power is also needed for actuators and for electronic calculation and control units and a sensor pack, which are responsible for maneuvering the vehicle. The sensor pack is a range of sensors adapted to allow the control unit to receive inputs relating to the surroundings, such that the vehicle may function as an autonomous vehicle.

To the sensor pack belong antenna means capable of picking up GPS or local positioning signals, such that the vehicle shall know its exact location and orientation at any given time in the field.

For supplement or substitute of the GPS or like system, the vehicle may comprise one or more camera or other vision systems, which record images of the surroundings and gleans off the camera position or position changes from such images. In this way the vehicle shall also be able to work autonomously in locations where GPS signals are not readily at hand, such as inside buildings or under dense forest cover.

In an embodiment, the weeding rod is intermittently moved in a direction transversely to the direction of motion. By performing such an additional step, the weeding rod may be introduced into the space between individual plants in a row of plants. Preferably the position of each plant in the row is known and when a robot equipped with the weeding rod knows its position and orientation, it may perform the weeding action between individual plants while advancing in the row and while weeding rods are kept in the ground between the crop rows.

In an embodiment, the weeding rod is advanced in a direction having an angle V with respect to a length axis between the proximal part and the distal part which angle is between 90 and 45 degrees, or between 90 and 65 degrees or between 90 and 85 degrees, or at 90 degrees. Lower angles between the direction of advancement and the length axis of the weeding rod shall ensure that no roots or dirt particles accumulate on the weeding rod, however it has surprisingly been learned, that even with the movement direction perpendicular to the length axis of the weeding rod, no such accumulations will take place and thus it is possible to advance the rod under the surface in a direction perpendicular to its length axis.

In yet another embodiment, the method comprises the following further steps: advancing the weeding rod along with several arrays of similar rods below ground level from a first end of a row of crops to a second end of the row, and at the second end of the row elevating the weeding rods out of the ground and rotating the arrays of weeding rods about a vertical center axis which is arranged within the arrays of rods. The rotation of the arrays and rods about one common axis ensures that the robot shall not need enlarged space at the ends of the rows of crops in order to perform a turn about and continue weeding at adjacent rows.

In a further aspect of the invention a weeding rod adapted to be used in the above method is provided, which is made from a steel rod, and has a straight part with a length axis between a proximal part where it is suspended and a distal part where it is un-suspended and where the rod is arranged parallel to a ground surface plane when in use, whereby the weeding rod at the proximal part comprises a portion which extends upwards with respect to a length axis of the rod and a ground surface plane. According to the invention, the weeding rod is made from a round steel rod which has a diameter of between 1 mm and 5 mm, such as 3 mm.

One material for the rods is steel, e.g., a 3 mm DIN17224, AISI 302 grade round steel rod is used. When the rods lack a sharp edge, they will wear down without essentially losing their rounded shape during wear. The upwardly extending part at the proximal end allows the weeding rod to be fixated here, such that the part between the fixated proximal part and the distal part may be moved along the ground plane embedded in the soil. The suspension at only one end of the weeding rod is advantageous in that it allows weeds and roots to slide off the rod at the unsuspended end. Various different fixations of the upwardly extending part are possible, and a vertical or near vertical fixation is typically used, however, fixations where the upwardly extending part is angled with respect to a ground plane would also be possible.

In an embodiment the weeding rod is arranged to be moved underneath a ground level in a direction angled with respect to the length axis between its proximal and distal parts whereby the angle is between 90 and 45 degrees, or between 90 and 65 degrees, or between 90 and 85 degrees, or at 90 degrees. It is to be mentioned that in order to weed between crop plants in a row, the weeding rod may be moved pivotally in a horizontal plane, and thus the angle between length axis and direction of motion will vary during the weeding operation. For other weeding rods this angle does not shift significantly and will stay within the specified limits, as long as the weeding rod is not subject to high strains. Excessive strains may result from accumulations on the weeding rod or objects like rocks and stones in the ground, and thus one may use a spring steel rod, which may yield backwards, and twist to pass by immovable objects without braking. The spring steel ensures that the weeding rod shall resume its specified position after a spring action.

In an embodiment, the weeding rod has a curved top at the proximal part thereof, and at the curved top it is connected to a further weeding rod which extends to a distal and unsuspended end thereof. Thus, the two weeding rods extend away from each other and are axially aligned but connected at the curved top. This allows convenient suspension of the two weeding rods at their common curved top.

In an embodiment, a weeding rod, at its proximal part, is fixated to a wagon above ground, whereby the wagon has a ground supporting wheel at each end thereof and is arranged to extend in a direction between the wheels parallel to the direction of motion of the weeding rod. The wagon and the wheels make sure that the intended working depth of the weeding rod may be maintained. This is ensured simply by the manual adjustment of a fixture between wagon and weeding rod, where the fixture comprises a vertical slitformed opening and well-known nut and bolt connection.

In a further embodiment the weeding rod, at its proximal part, is fixated to an arm, which arm is movably connected to the wagon and adapted to move in a transverse direction relative to the forward motion of the wagon. This arrangement allows the movable arm to be guided in between the individual plants in the crop row controlled, for example, by GPS signals to avoid the weeding rod destroying the crop. This movement may alternatively or additionally be controlled by vision systems or other sensory detection of the crop plant.

In an embodiment, an array of weeding rods is attached to each wagon, and an array of wagons is provided side by side and the array of wagons has a set of ground engaging drive wheels at one end and a ground support castor wheel at the opposed end whereby the array of wagons is arranged and adapted to be moved relative to the drive wheels towards or away from the ground. The array of weeding rods on each wagon may all be fixed to the wagon, or a portion thereof may be movable with respect to the wagon. The motion of the wagons up and down with respect to the ground engaging drive wheels is used to move all weeding rods up and out of the ground, when the robot has to re-locate in order to start weeding in another set of crop rows.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 shows a schematic 3d partial view of an autonomic farm vehicle equipped with weeding rods according to the invention;

FIG. 2 shows a schematic 3d representation of the entire autonomic farm vehicle shown in part in FIG. 1;

FIG. 3 shows a perspective view of the weeding rod and its suspension;

FIG. 4 shows a perspective view of the weeding rod in FIG. 3, but displayed from a different angle;

FIG. 5 is the weeding rod seen in plain view;

FIG. 6 is a sideview of the suspension and weeding rod without clutch irons;

FIG. 7 is a plane view of an alternative embodiment of the weeding rod and suspension;

FIG. 8 shows a further alternative embodiment of a weeding rod at a suspension thereof;

FIG. 9 shows a further embodiment of a weeding rod;

FIG. 10 is an enlarged sideview of the solution shown in FIG. 9;

FIG. 11A shows a schematic view of weeding rods from above;

FIG. 11B shows a schematic view of weeding rods from above;

FIG. 11C shows a schematic view of weeding rods from above;

FIG. 11D shows a schematic view of weeding rods from above;

FIG. 12 shows a singled-out wagon next to a crop row in a 3d view mode;

FIG. 13 shows the wagon in FIG. 12 in a plane sideview; and

FIG. 14 shows the wagon from FIG. 12 in a plane view from a rearmost side.

### DETAILED DESCRIPTION

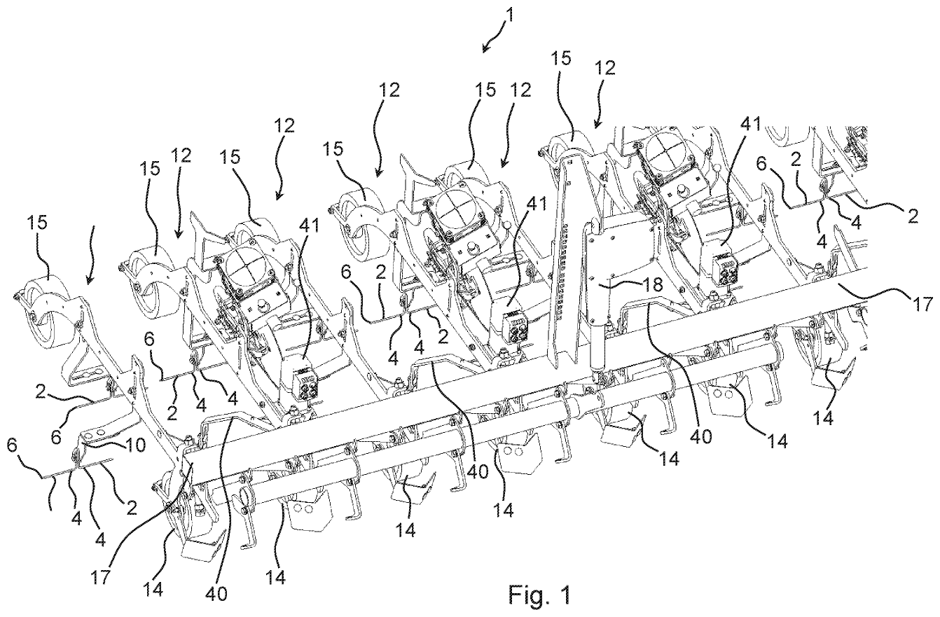

Referring now in detail to the drawings for the purpose of illustrating embodiments of the present invention, weeding rods 2 of the present invention are illustrated in FIG. 1 along with a farm robot 1 for the deployment of an automatic weeding action.

FIG. 1 shows a schematic 3d partial view of an autonomic farm vehicle or robot 1 equipped with weeding rods 2 according to the invention. Each weeding rod 2 comprises a horizontal part, which extends essentially perpendicular to the principal direction of movement of the vehicle 1, when it is performing a weeding operation. Each rod 2 further has a vertical or upright part 8 connected to the horizontal part at a proximal part 4 thereof, whereby the vertical or upright part 8 is suspended from a suspension iron 10, which is bolted to a wagon 12.

The entire horizontal part is to be embedded in the soil when at work and moved transversely to its length direction. This movement will impart a momentum on the supported part of the rod, and to keep this momentum low relative to the diameter of the rod, the diameter/length relation must be kept reasonable. For example, a diameter to length relation for the rod length between the proximal suspended part and the distal unsuspended part may be between 1:10 and 1:50 and typically it should be around 1:26. When a 3 mm iron rod is used, the length between the distal part and the proximal part thus shall be around 80 mm. The length measure is not necessarily exact as production methods may leave some tolerances within which the rod is made. Present day highly resilient steel types will allow this length to diameter relation to function under most conditions and with the specified speed limits for the forward movement of the rods in the ground. Initially the weeding rod shall have a circular cross section, but with wear, this cannot be maintained. However, as wear is evenly distributed on the surface part facing the direction of movement, the shape shall remain rounded and possibly oval and this results in that there will not be any sharp edge part which could cut weed roots.

Each wagon 12 comprises a pair of wheels namely a leading front wheel 14 at a front end and a trailing rear wheel 15 at a back end, whereby the trailing wheel 15 is arranged to run in the track of the leading wheel 14, and whereby several weeding rods 2 are provided between the two wheels 14,15. The rods 2 thus protrude transversely towards both sides from a wagon length axis defined by the two wheels 14,15. Each wagon 12 is linked to a chassis of the vehicle and may be lifted with respect to the chassis part when the weeding rods 2 are to be lifted out of engagement with the ground. Preferably a linking mechanism establishes a parallel lifting action with respect to the chassis, such that wagon front and rear wheel 14,15 are lifted simultaneously away from the ground whenever a weeding action comes to an end.

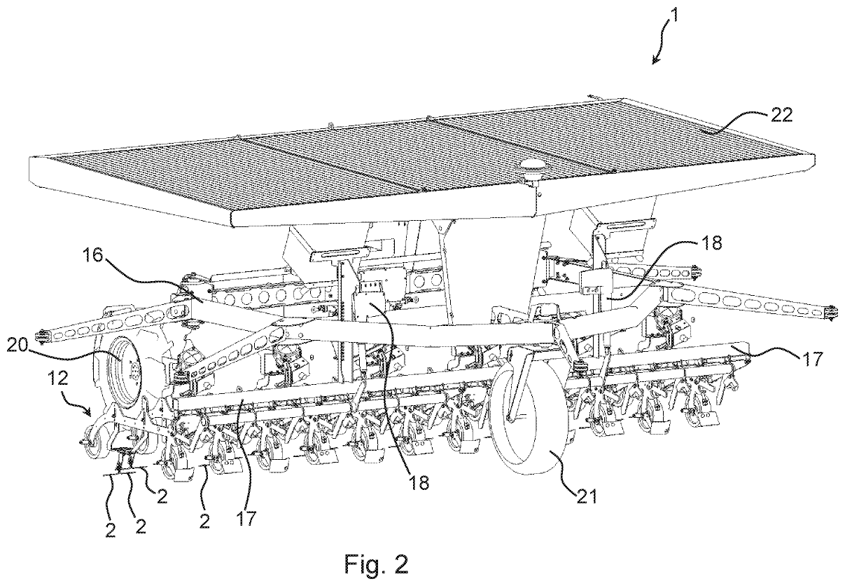

FIG. 2 shows a schematic 3d representation of the entire autonomic farm robot vehicle 1 shown in part in FIG. 1. The chassis comprises among other parts, an upper frame 16 and attached thereto a front transverse bar 17 where an array of the described wagons 12 is linked. The linkage mechanism is not described in any further detail; however, two actuators 18 are shown which may move the linkage mechanism for the translation of the wagons 12 up and down with respect to the chassis.

Also seen in FIG. 2, a pair of driving wheels 20 (only one is shown) and a front castor wheel 21 is provided, such that the driving wheels impart motion to the vehicle 1 with respect to the ground when they are rotated. The castor wheel 21 is at the front of the vehicle 1, and it turns around a vertical suspension axis according to a speed difference between the driving speeds of the two driving wheels 20, which are at the back end of the vehicle. Above the chassis there is mounted a solar panel 22, which may provide electrical power for the driving motion. Also, the vehicle 1 may comprise a number of batteries or other power releasing devices (not shown) in order to ensure propulsion power to the driving wheels 20. Electrical power is also needed for actuators and for electronic calculation and control units and a sensor pack, which are responsible for maneuvering the vehicle. To the sensor pack belongs antenna means capable of picking up GPS or local positioning signals, such that the vehicle shall know its exact location and orientation at any given time in the field.

The vehicle 1 is guided along predefined rows of crops (not shown) such as turnips or similar vegetables used for human consumption or animal feed and the dirt surface between the rows shall be tilled with the horizontally extending weeding rods 2, which shall be pushed along parallel to the surface, but between 1 cm and 3 cm, typically 1.50 cm, below surface.

The weeding rods 2 are made from round iron rods, which have a diameter between 1 mm and 7 mm, or between 1 mm and 5 mm, and typically 3 mm. A suitable material for the rods is steel, and typically a 3 mm DIN17224, AISI 302 grade round steel rod is used. When the rods 2 lack a sharp edge, they will wear down without essentially loosing their rounded shape. This rounded shape is responsible for the efficient weeding action, as roots of newly sprouted weeds are especially easy to pull out of the ground, which is what the weeding rods 2 do. It has been established, that pulling the weed roots out of the ground is a superior weeding tactic over cutting weed roots, which would have been the result of the weeding action of an implement with a sharpened edge.

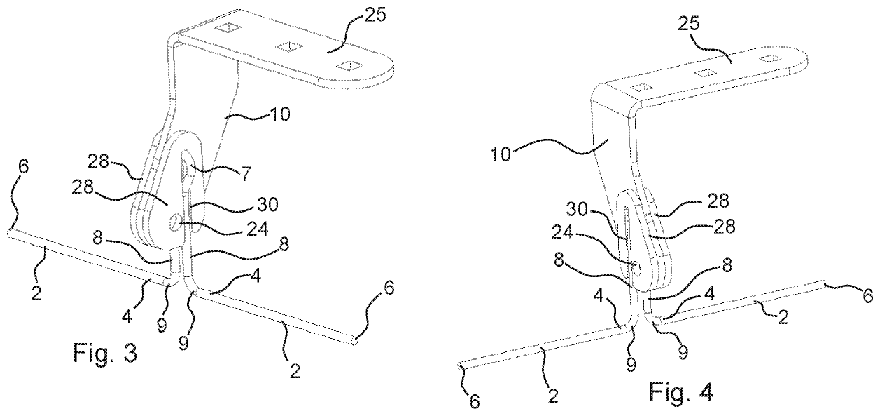

FIG. 3 and FIG. 4 disclose the suspension of the weeding rod 2. This suspension is arranged from a downwardly extending iron bar 10, which at its top comprises an angled portion 25, which has bolt holes for the fastening thereof to the corresponding wagon 12.

Two weeding rods 2 are provided at each suspension and the two rods 2 extend horizontally away from each other via their proximal part 4 in opposing, but axially aligned, directions of the suspension, transversely of a dominant movement direction, such that a proximal part 4 of each weeding rod is fixated and clutched at the lower end of the suspension iron bar 10, and a distal part 6 of the weeding rod 2 is un-supported.

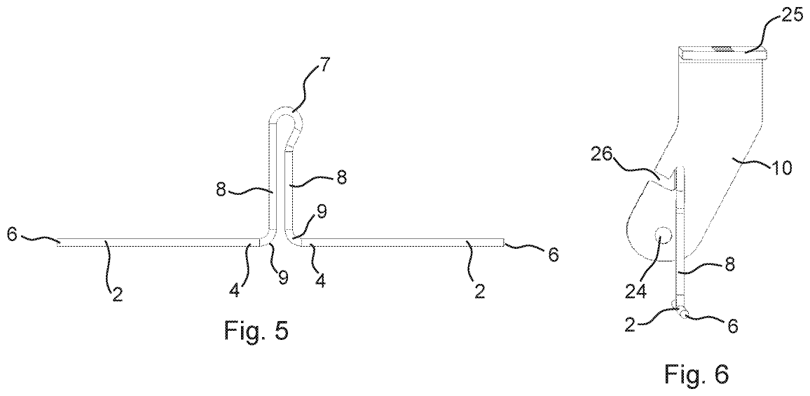

As can be seen in FIG. 5, the two proximal parts 4 of the weeding rods 2 are connected at the suspension, and usually the two weeding rods 2 are made from one length of iron rod, which has been bent to shape the two axially aligned weeding rods 2, which extend in each of their directions away from the proximal part 4, which part 4 is connected to a curved top 7 through two upwardly extending or vertical parts 8. Each such vertical part 8 is connected to its weeding rod 2 through a curved connection part 9, which connects the horizontal weeding rod 2 with the vertical part 8 through a 90-degree curve.

In FIG. 6 the downwardly extending suspension iron bar 10 is visible, and it can be seen that it has a through-going track 26 which leads from an edge part and slopes downward towards the center of the bar 10, and then changes direction to slope upwards from a lowermost position. This shape ensures a downwardly extending locking nose, which, when iron clutches 28 are added prevents the upper curved top 7 of the weeding rod 2 from sliding out of the track 26.

The clutches 28 are added at each side of the suspension iron bar 10, and by way of a bolt and nut (not shown) they shall be fixated towards the sides of the iron bar 10. A hole 24 passes through the iron bar 10 and the two clutches 28 to accommodate the bolt. As seen in FIG. 3 and FIG. 4 each clutch 28 comprises a linear track 30 for the accommodation of the two vertical parts 8 of the weeding rods 2. The tracks 30 extend from a lower edge and upwards to an apex part of each clutch 28. The tracks 30 themselves will allow the curved top 7 of the weeding rods to slide vertically therein, but as the through going track 26 in the suspension iron bar 10 is sloping with respect to the vertical direction at its upper end, the iron clutches 28 shall prevent vertical movement of the curved top 7 once the clutches 28 are clamped to the sides of the iron bar 10.

This arrangement shall allow the weeding rods 2 a little slack when mounted to the iron bar 10, and especially the linear tracks 30 in the clutches 28 shall not prevent the vertically extending parts 8 at the proximal part 4 of each weeding rod 2 to turn or twist around its vertical axis, and such a twist allows the horizontally extending weeding rod 2 to become angled backwardly with respect to its movement direction in the soil. Such an angulation may take place if solid objects in the ground such as stones or dropped farming implements are encountered, or if roots from weeds and dirt have accumulated on the weeding iron and impedes its movement beneath the surface. This movement along with the possible spring action of each weeding rod allows any accumulated matter on each rod to slide outwardly towards the distal part 6 and thus the accumulation of dirt or roots will not hamper the function of the weeding rod.

It shall also be noticed that two weeding rods are suspended with one and the same bolt-and-nut connection, and thus it is both easy and fast to perform exchange of weeding rods when they have been worn down. In this connection it shall be mentioned that the relative low speed of the weeding rods in the ground minimizes wear on them.

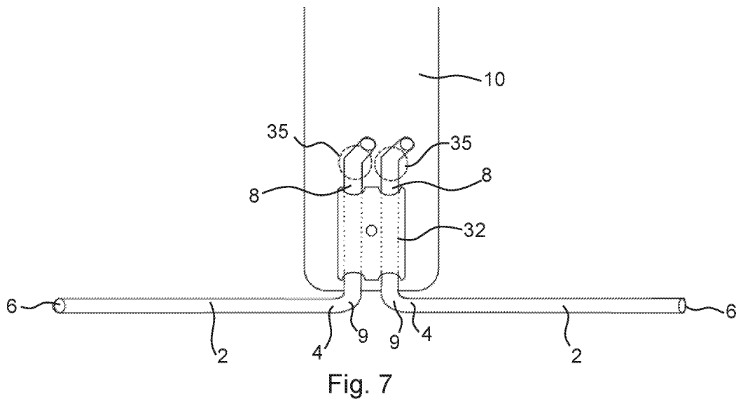

FIG. 7 discloses an alternative suspension of the weeding rods at a suspension thereof. Here the two weeding rods 2 shown are not interconnected directly, but each comprises a vertical part 8, which is attached to the suspension iron bar 10 by way of a locking clamp 32, which tightens the vertical parts of each rod 2 by a nut and bolt connection 34 schematically indicated. Each vertical part 8 has at its upper end an angled portion 35, which is secured to the iron bar 10 by being allowed to protrude through a hole in the bar 10.

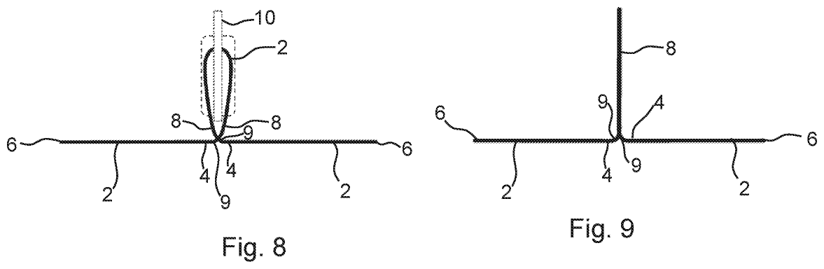

FIG. 8 shows a further alternative embodiment of a weeding rod 2 at a suspension thereof. Here the vertical parts 8 are made as a loop such that the horizontal rod 2 at the bend 9 loops upwards at an opposed side of the iron suspension bar 10 and goes through a slit in the suspension bar 10 at a curved top 7 and loops downward to join with a further horizontal rod 2. Clutches 28 are provided as explained with respect to FIGS. 3 and 4.

FIG. 9 shows a further embodiment of a weeding rod 2, where the vertical part of each of two rods are connected at an apex thereof and follow each other upward in a plane perpendicular to the axis direction of the horizontal parts.

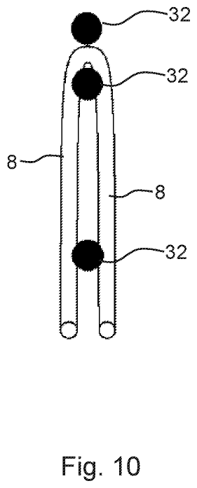

FIG. 10 shows the vertical parts in plane view, seen from an endpart of the horizontal element. The vertical elements are clamped by screw or similar onto a suspension iron (not shown) and above the apex there is a clamp or bolt 32 to prevent the weeding rods from moving upwards.

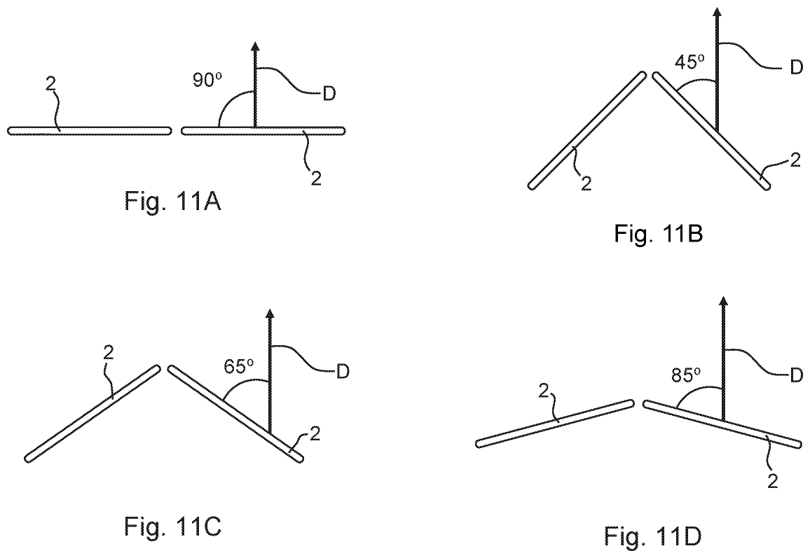

In the FIGS. 3-10 the pair of weeding rods mounted to the suspension bar 10 each extend transversely to the principal direction of movement, however it is possible by twisting the vertical part 8 of the weeding rod, or by provision of a further bend in a horizontal plane to let each rod run more or less angled with respect to a movement direction. This is indicated schematically in FIGS. 11A-11D. In these figures the weeding rods are seen from above, and the arrow marked D indicates the principal direction of motion of the weeding rods in the ground. In FIG. 11A the pair of rods are disclosed which move perpendicular to their common length axis in the ground commensurate with the indications in FIGS. 3-10. In FIG. 11B the weeding rods are angled backwardly with respect to the direction D with an angle of 45°. Thus, each rod 2 is suspended at its foremost part in the direction of movement and unsuspended at a rearmost part. This aids in keeping the rod clean during its action in the ground. In FIG. 11C the angle is 65 degrees and in FIG. 11D the angle is 85 degrees.

The angulation of the weeding rod with respect to the direction of motion will, when in use, also impart a small sideways force on the surface dirt being tilled by the rod, and if the rod is moved many times over in the same trace, this may cause some longitudinal furrows to evolve in the field, which is not desired. For this reason also, it is usually preferred to keep the weeding rods perpendicular to the direction of motion.

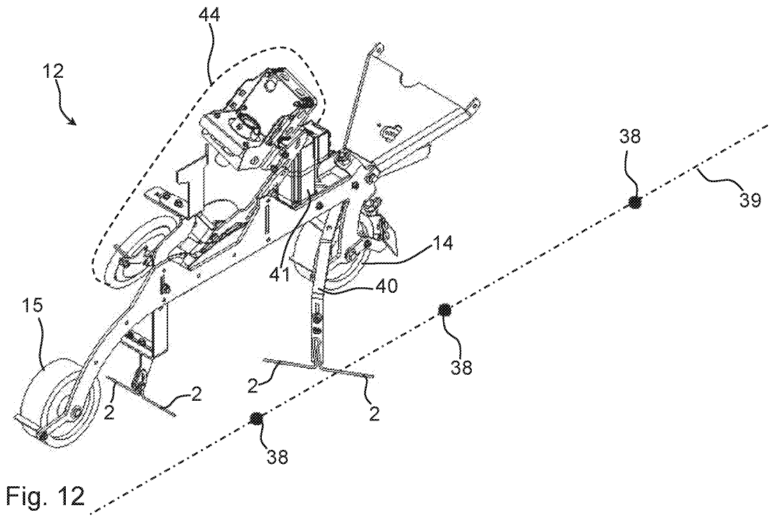

FIG. 12 shows a singled-out wagon 12 next to a crop row in a 3d view mode. The crop plants 38 are disclosed in a row 39 as is the usual way of sowing or planting different types of crops used in agriculture. In between rows it has long been customary to drive a weeding implement along using tractors but between the individual plants in a row, it is to this day still customary to weed by hand power or rely on chemical agents to suppress weed growth. When the seeds for the crop have been placed precisely according to GPS coordinates as it is known with newly developed sowing robots, a weeding robot may perform weeding between the individual plants while at the same time the robot weeds between the crop rows. To do this, the wagon 12 disclosed in FIG. 12 comprises a weeding rod pair 2, which are provided on a pivotal arm 40. The pivotal arm is seated at a hinge 42 or rotational axle, on the wagon 12 in order to pivot back and forth between two positions guided by an electrical engine 41. In a first position, the arm 40 is retracted and pivoted such that the weeding rods 2 do not interfere with the crop plants 38 in the row 39, and in the second position the arm 40 is rotated or pivoted around the rotation axle 42, such that the weeding rods 2 are place between two consecutive plants in the row 39. As the position of each plant 38 is known in advance, it is possible to calculate the timing of the pivotal movement of the arm to avoid damage to the crop plants and at the same time obtain a tilling and weeding action of the earth between the plants 38.

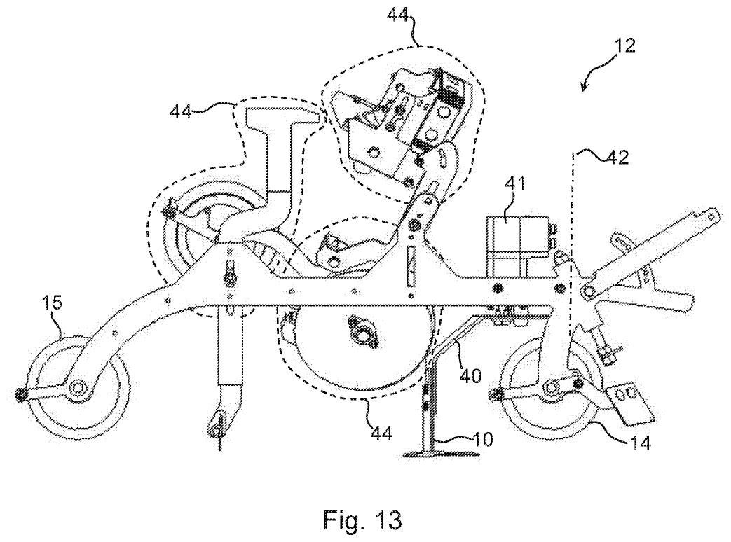

FIG. 13 shows the wagon 12 in FIG. 12 in a plane sideview, and here the electrical engine 41 and hinge 42 are shown.

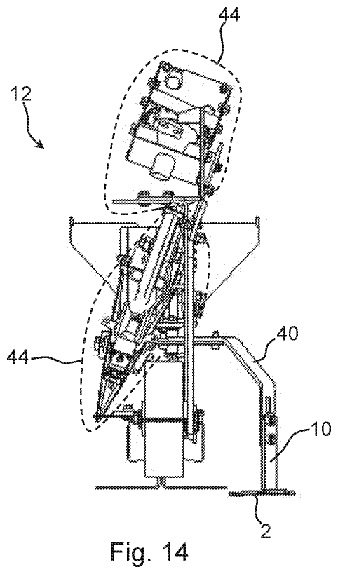

FIG. 14 shows the wagon 12 from FIG. 12 in a plane view from a rearmost side.

In FIGS. 12, 13 and 14 an assembly 44 is visible at the wagon 12, and similar assemblies 44 are visible at the array of wagons at the robot displayed in FIGS. 1 and 2. This assembly is used when the robot is used in sowing operations and is not used during weeding action. However the assembly may be pivoted into sowing position with the loosening of a few bolt and nut connections, and similarly the weeding implements are easily taken out of use and placed in a position above the wagon, such that they do not interfere with a sowing operation.

The back and forth pivotal movement of the arm 40 may be linked to a cam follower element (not shown), such that the arm is lifted to retract the weeding rods out of the soil when the arm is not advanced for weeding between the crop plants, and is lowered down for engagement with the soil when pivoted to weed between the plants.

Weeding rod depth is individually adjustable by simple and known measures. In FIG. 12 it can thus be seen that the foremost weeding rod pair on the wagon is connected to a frame member of the wagon through a vertically shaped slit therein, and similarly the pivotally mounted rod assembly may be moved up and down manually by the suspension iron 10 being connected to the pivotal arm 40 through a similar vertical slit in which is seated a bolt and nut connector pair.

### LIST OF REFERENCE NUMERALS

1—Farm robot

2—Weeding rods

3—Proximal part

6—Distal part

7—Curved top

8—Vertical part

9—Curved connection part

10—Suspension iron bar

12—Wagon

14—Front wheel

15—Back wheel

16 Upper frame

17—Transverse bar

18—Actuators

20—Driving wheels

21—Front castor wheel

22—Solar panel

24—Hole

25—Angled portion

26—Through going track

28—Iron clutches

30—Linear track

32—Locking clamp

35—Angled portion

34—Lower clamp

36—Upper clamp

38—Crop plant

39—Crop plant row

40—Pivotal arm

41—Electrical engine

42—Hinge

44—Assembly

What is claimed is:

1. A method for weeding between rows of crops with a weeding rod suspended from a vehicle part at a proximal portion of the weeding rod and left un-suspended at a distal portion thereof, the distal portion and the proximal portion in the same horizontal plane, the method comprising the steps of:
ensuring that the weeding rod has a rounded cross section in a transverse plane with respect to a length axis thereof between the proximal portion and the distal portion; and
advancing the weeding rod below ground level in a direction of motion along a ground plane at a speed between 0.3 and 5 km/h,
wherein the weeding rod comprises a vertical part connected to the proximal portion.

2. The method according to claim 1, wherein the vehicle includes a sensor pack comprising an antenna receiving positioning signals, such that the vehicle knows its exact location and orientation at any given time.

3. The method according to claim 1, wherein the weeding rod is intermittently moved in a direction transverse to the direction of motion in order to perform a weeding action between individual plants in an adjacent row of crop plants.

4. The method according to claim 1, wherein the weeding rod is advanced in a direction having an angle between 90 and 45 degrees with respect to the length axis.

5. The method according to claim 1, wherein the weeding rod is advanced in a direction having an angle between 90 and 65 degrees with respect to the length axis.

6. The method according to claim 1, wherein the weeding rod is advanced in a direction having an angle between 90 and 85 degrees with respect to the length axis.

7. The method according to claim 1 further comprising:
advancing the weeding rod along with several arrays of similar rods below ground level from a first end of a row of crops to a second end of the row; and
at the second end of the row elevating the weeding rod and the several arrays of similar rods out of the ground and rotating the weeding rod and the several arrays of similar rods about a vertical center axis.

8. The method according to claim 1, wherein the weeding rod comprises a straight part along the length axis between the proximal portion where it is suspended and the distal portion where it is un-suspended, the straight part of the weeding rod arranged parallel to the ground plane when in use, and wherein the weeding rod at the proximal portion comprises a vertical part that extends upwards with respect to the length axis.

9. The method according to claim 1, wherein the weeding rod is made from a round steel rod having a diameter between 1 and 5 mm.

10. The method according to claim 1, wherein the weeding rod at the proximal portion has a curved top connected to a further weeding rod that extends to a distal and unsuspended end.

11. The method according to claim 1, wherein the weeding rod at the proximal portion is fixed to a wagon above ground, the wagon having a ground supporting wheel at each end and arranged to extend in a direction between the wheels parallel to the direction of motion of the weeding rod.

12. The method according to claim 11, wherein the weeding rod at its proximal portion is fixed to an arm that is movably connected to the wagon and adapted to move in a transverse direction relative to the direction of motion of the wagon.

13. The method of claim 11, further comprising a plurality of wagons provided side-by-side and having a set of ground engaging drive wheels at one end and a ground support castor wheel at an opposed end whereby the plurality of wagons is arranged and adapted to be moved relative to the drive wheels towards or away from the ground.

14. The method according to claim 13, wherein an array of weeding rods is attached to each wagon in the plurality of wagons.
